(19) United States
(12) Patent Application Publication
(10) Pub. No.: US 2009/0284788 A1
(43) Pub. Date: Nov. 19, 2009

(54) IMAGE FORMING APPARATUS AND CONTROL METHOD THEREOF

(75) Inventor: Atsushi Shoji, Kawasaki-shi (JP)

Correspondence Address: FITZPATRICK CELLA HARPER & SCINTO, 1290 Avenue of the Americas, NEW YORK, NY, 10104-3800, US

(73) Assignee: CANON KABUSHIKI KAISHA, Tokyo (JP)

(21) Appl. No.: 12/437,298

(22) Filed: May 7, 2009

(30) Foreign Application Priority Data
May 14, 2008 (JP) 2008-127379

(51) Int. Cl. G06F 15/00; H04N 1/04

(52) U.S. Cl. 358/1.15; 358/474

(57) ABSTRACT

An electrophotographic image forming apparatus increases resolution in the main scanning direction. To accomplish this, the image forming apparatus includes a light source having N light-emitting portions each configured to emit a light beam based on an input image signal, an input unit which inputs image data, a signal generation unit which extracts one-scanning image data corresponding to one scanning based on the input image data, and generates N image signals that form one-scanning image data upon composition, and a scanning control unit which scans a single track on a photosensitive body by N light beams emitted by the light source to form a latent image corresponding to one-scanning image data on the photosensitive body.

### BACKGROUND OF THE INVENTION

1. Field of the Invention

The present invention relates to a technique of performing image formation by forming a latent image by optical scanning.

2. Description of the Related Art

In an electrophotographic image forming apparatus, a latent image optically rendered on a photosensitive body is developed with toner. The developed toner image is transferred onto a sheet. The transferred image is fixed to the sheet by heat and pressure, thereby forming and outputting the image. To form a more intricate, finer image, the image forming apparatus requires a higher-resolution rendering mechanism. To increase the productivity, the image forming speed is preferably high. To double the image forming speed without changing the image forming resolution, the frequency of the rendering clock needs to be doubled. Further, to double the image forming resolution in the main scanning direction and sub-scanning direction without changing the image forming speed, the frequency of the rendering clock needs to be quadrupled.

Early laser printers had an image forming speed of eight sheets per min and an image forming resolution of about 300 dpi. Today's laser printers have attained a printout speed of several ten sheets per min. The mainstream of the image forming resolution in recent electrophotographic digital copying machines is 600 dpi. Some models achieve an image forming resolution of even 1,200 dpi or more. Thus, the laser needs to be driven at a speed as high as at least 30 to 100 times. To provide a high-quality printout without decreasing the productivity, printers need to be driven at higher speeds, and thus require a laser element capable of ON/OFF-controlling emission at high speed, and an electronic circuit for driving it. At the same time, for high-speed scanning, the working accuracy and operation accuracy of the optical and mechanical systems must be increased. When the speed is increased while employing the same method as the conventional one, the cost of components used and the manufacturing cost rise exponentially.

To increase the image forming speed and image forming resolution, there is proposed a method of simultaneously scanning a plurality of scanning lines using a plurality of light beams. To reduce the adjustment cost and prepare multiple light sources at low cost, it is particularly effective to form a plurality of light sources on one chip. For example, Japanese Patent Laid-Open No. 2006-198882 discloses a method of increasing the sub-scanning resolution using such a one-chip device.

As described above, simultaneous scanning using multiple light sources can increase the image forming resolution and image forming speed in the sub-scanning direction. To the contrary, the resolution in the main scanning direction can only be increased by increasing the frequency of a rendering signal. However, emission of a semiconductor laser serving as a general light source is becoming too slow for a higher rendering signal frequency.

The laser oscillates, and takes time until it stabilizes in a steady state after the start of oscillation. The laser light source starts oscillation in accordance with ON/OFF control of a rendering signal. Thus, the laser light source always suffers a time lag (response delay) until the light quantity with respect to a rendering signal stabilizes, deteriorating the signal. In early laser printers, the emission time lag is very short (less than 1%) with respect to the minimum pulse in rendering, and is negligible. However, in current high-speed, high-resolution products, the minimum pulse width in rendering and the time lag till the start of laser oscillation are reaching the same order. The time lag is therefore no longer non-negligible.

A correction technique using an electronic circuit can be applied to isolated pulse rendering. More specifically, when a device has a low response speed with respect to a rendering signal, a circuit which extends the pulse by the response delay is formed from a logic circuit or electronic circuit to correct (compensate) the emission time.

FIG. 1 is a timing chart showing the waveforms of electrical signals before and after correction, and corresponding emission patterns. FIG. 2 is a circuit diagram showing an example of a pulse extension circuit serving as a simplest correction circuit. According to the simplest pulse width extension method, a signal is divided to input one to an OR circuit via a delay element and the other directly to the OR circuit. DL represents a delay element, and the logic circuit generates a delay time delay. The waveform of a signal having passed through the delay line provides a pulse delayed by the delay time delay. The OR makes two pulses overlap each other to extend them by the delay time delay of the delay circuit. Note that the delay width is smaller than the pulse length.

That is, the emission delay is corrected by adjusting the emission delay time τ and the pulse signal delay time delay to be equal to each other. However, the signal timing is delayed by τ as a whole, so the delay time τ is also corrected.

In this manner, the emission delay can be canceled in a discrete pulse signal. However, in rendering by an image forming apparatus, rendering pulses of the laser are not always discrete. For example, when an error diffusion texture or hatched pattern for tone expression, a kanji character having many strokes, or the like is rasterized into a bitmap image, rendering pulses form a highly dense pattern in an extracted array image. FIG. 3 is a timing chart exemplifying a state in which a highly dense rendering pattern is not normally reproduced. As shown in FIG. 3, if a highly dense rendering pattern is corrected using an electronic circuit, all adjacent pulses are coupled to each other, failing to reproduce an optically rendered image normally. If a highly dense rendering pattern is not corrected using an electronic circuit, many isolated pulses disappear, and an optically rendered image cannot be reproduced normally. The resolution in the main scanning direction can be increased by only increasing the frequency of a rendering signal. However, increasing the frequency has almost reached its limit. Thus, increasing the resolution in the main scanning direction is also approaching its limit.

The present invention provides a technique capable of increasing resolution in the main scanning direction.

### SUMMARY OF THE INVENTION

According to one aspect of the present invention, an image forming apparatus comprises: a light source having N (N is an integer of not less than 2) light-emitting portions each configured to emit a light beam based on an input image signal; input unit for inputting image data; signal generation unit for extracting one-scanning image data corresponding to one scanning based on the input image data, and generating N image signals which form the one-scanning image data upon composition; and scanning control unit for scanning a single track on a photosensitive body by N light beams emitted by the light source to form a latent image corresponding to the one-scanning image data on the photosensitive body.

According to another aspect of the present invention, a method of controlling an image forming apparatus using a light source having N (N is an integer of not less than 2) light-emitting portions each configured to emit a light beam based on an input image signal, the method comprises: an input step of inputting image data; a signal generation step of extracting one-scanning image data corresponding to one scanning based on the input image data, and generating N image signals which form the one-scanning image data upon composition; and a scanning control step of scanning a single track on a photosensitive body by N light beams emitted by the light source to form a latent image corresponding to the one-scanning image data on the photosensitive body.

The present invention can provide a technique capable of increasing resolution in the main scanning direction in an electrophotographic image forming apparatus.

Further features of the present invention will become apparent from the following description of exemplary embodiments with reference to the attached drawings.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a timing chart showing the waveforms of electrical signals before and after extension, and corresponding emission patterns (prior art);

FIG. 2 is a circuit diagram showing an example of a pulse extension circuit serving as a simple correction circuit (prior art);

FIG. 3 is a timing chart exemplifying a state in which a highly dense rendering pattern cannot be normally reproduced;

FIG. 4 is a timing chart exemplifying processing of an input line signal;

FIG. 5 is a block diagram showing the internal arrangement of an image forming apparatus according to the first embodiment;

FIG. 6 is a view exemplifying a state in which the timing arbitration mechanism of the image forming apparatus according to the first embodiment transfers data to an optical scanning mechanism;

FIG. 7 is a view exemplifying a state in which the timing arbitration mechanism of an image forming apparatus according to the second embodiment transfers data to an optical scanning mechanism;

FIG. 8 is a view exemplifying the layout of laser diodes on a semiconductor chip;

FIG. 9 is a view exemplifying an optical system included in an optical scanning mechanism 304 used in the image forming apparatus according to the first embodiment;

FIG. 10 is a view exemplifying a light source arrangement in a device with a repetitive arrangement;

FIG. 11 is a view exemplifying an image signal in each internal mechanism of the image forming apparatus;

FIG. 12 is a view exemplifying deformation of a formation image according to the fourth embodiment; and

FIG. 13 is a flowchart of the operation of the image forming apparatus according to the first embodiment.

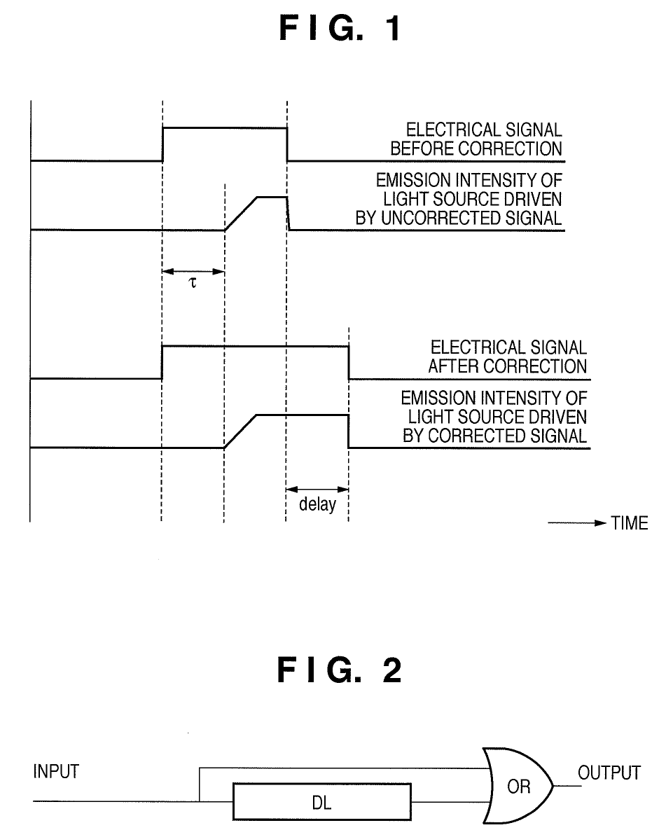

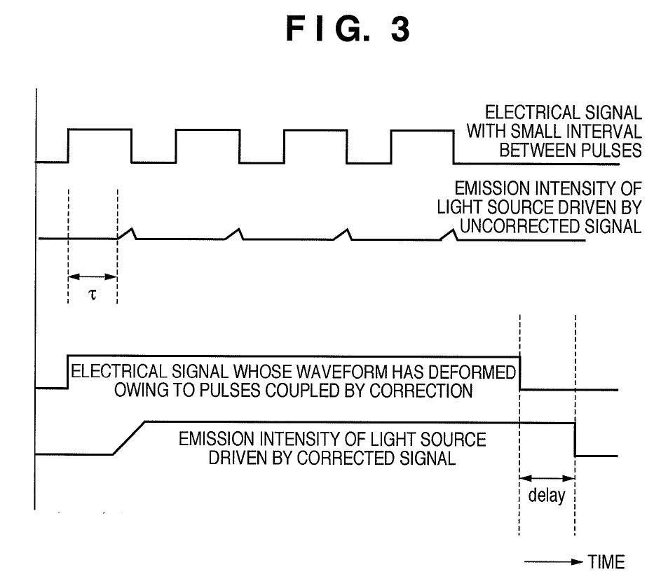

### DESCRIPTION OF THE EMBODIMENTS

Preferred embodiments of the present invention will be described in detail below with reference to the accompanying drawings. The following embodiments are merely examples, and may not be construed to limit the scope of the present invention.

### First Embodiment

An image forming apparatus according to the first embodiment of the present invention will be described by exemplifying an image forming apparatus configured to scan a single track by a light source having N (N is an integer of 2 or more) light-emitting portions which are arranged one-dimensionally on the light source. Signal (pulse) processing will be explained using a circuit which assumes positive logic. Needless to say, a pulse can also be generated using a negative-logic circuit.

<Apparatus Arrangement>

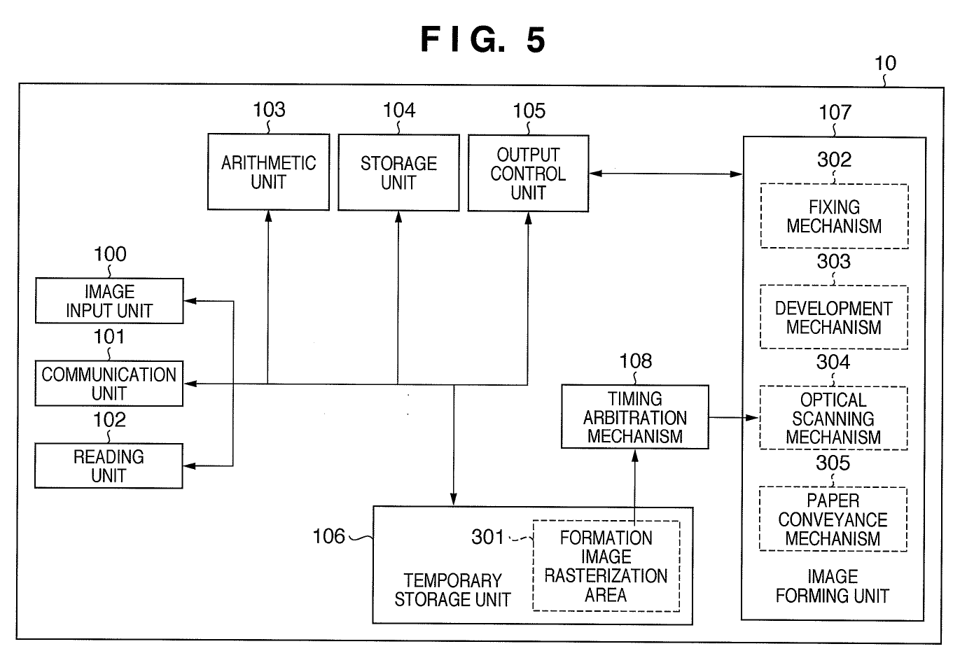

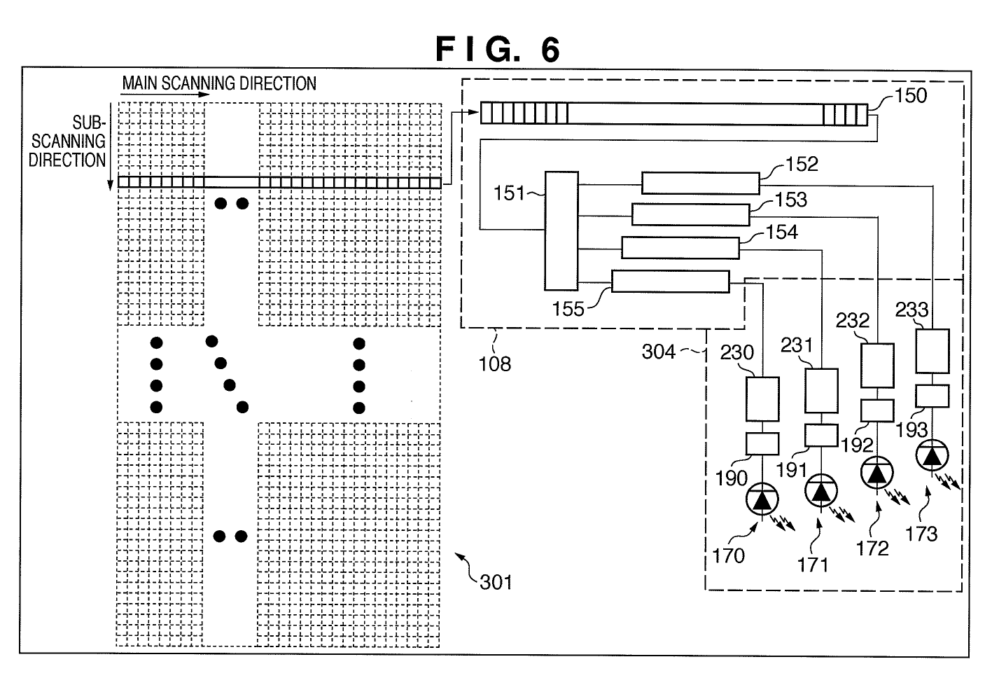

FIG. 5 is a block diagram showing the internal arrangement of the image forming apparatus according to the first embodiment.

An image forming apparatus 10 includes at least one of a communication unit 101 for an external device, a reading unit 102 for an external storage, or an image input unit 100 in order to acquire image information (image data) used to form and output an image. Input image information can be corrected by image processing complying with each device characteristic in accordance with the acquisition method of the image information. Further, the image information can be converted and corrected in accordance with the device-specific output characteristic. These correction processes are executed using software, hardware, or a combination of them. For example, when image information is input from a scanner or the like, noise is removed or the tone characteristic is corrected.

An arithmetic unit 103 executes a program stored in a storage such as a ROM, and executes various control operations in the apparatus. The arithmetic unit 103 analyzes the format of input image information, converts it into an image data structure used in the image forming apparatus 10, and generally generates a bitmap image. After performing a variety of processes for the bitmap image, the arithmetic unit 103 outputs a formation image to be used by an image forming unit 107 (to be described later).

A storage unit 104 saves information such as program descriptions and set values which should be held even when, for example, power is OFF and the image forming apparatus is not used, so as to prevent an error when the image forming apparatus operates. The storage unit 104 is generally formed from a ROM, flash memory, or the like.

A temporary storage unit 106 stores information which may be lost when, for example, power is OFF and the image forming apparatus is not used. The temporary storage unit 106 is generally formed from a RAM or the like. A formation image rasterization area 301 is reserved in a partial area of the temporary storage unit 106.

An output control unit 105 controls each mechanism included in the image forming unit 107 (to be described later) in accordance with an instruction from the arithmetic unit 103. The output control unit 105 acquires information necessary for control from each unit in the image forming apparatus 10.

The image forming unit 107 executes electrophotographic image formation. The image forming unit 107 includes a paper feed/conveyance mechanism 305, optical scanning mechanism 304, transfer/development mechanism 303, and fixing mechanism 302.

The paper feed/conveyance mechanism 305 feeds a sheet for use from one or a plurality of sheets to a sheet conveyance path, and conveys it in the image forming unit 107. The paper feed/conveyance mechanism 305 receives, from the output control unit 105, information on the conveyance timing and the rendering timing of a sub-scanning pixel.

The optical scanning mechanism 304 emits a light beam such as a laser beam to render an image on a photosensitive body based on image information stored in the formation image rasterization area 301. Information needs to be transferred from the formation image rasterization area 301 to the optical scanning mechanism 304 at a strict timing and high speed. In general, hardware executes the transfer. More specifically, timing arbitration by hardware, and a dedicated communication line control line are adopted. In FIG. 5, a timing arbitration mechanism 108 functions as this hardware.

The image forming apparatus 10 has many other movable units and control targets. For example, the arithmetic unit 103 executes various control programs stored in the storage unit 104 to control the respective units.

FIG. 6 is a view exemplifying a state in which the timing arbitration mechanism of the image forming apparatus according to the first embodiment transfers data to the optical scanning mechanism.

A line buffer 150 is a temporary storage capable of asynchronously executing read and writes of data. The timing arbitration mechanism 108 loads a formation image, which is saved in the rasterization area 301, into the line buffer 150 for each main scanning line. The timing arbitration mechanism 108 outputs the formation image to the optical scanning mechanism 304 in synchronism with the rendering timing of the optical scanning mechanism 304. More specifically, based on a timing signal generated by the optical scanning mechanism 304, the timing arbitration mechanism 108 outputs line information of the formation image loaded in the line buffer 150.

There are several methods of scanning the photosensitive body with light beams emitted by light sources 170 and 173. According to one method, light is guided to a rotating mirror surface to scan the photosensitive body. The reflected light scans the photosensitive body at a constant speed via an optical system. By rotating the mirror surface, the dead time not contributing to scanning is shortened to prolong the scanning time on the photosensitive body and reduce pixel clocks. As the mirror surface, a polygon mirror having a plurality of surfaces is used.

Depending on the working accuracy of the polygon mirror, scanning by the optical scanning mechanism 304 may vary in the image forming position, pixel size, and the like for each scanning. In general, the timing needs to be arbitrated again every scanning in order to absorb different mirror surface variation factors arising from the working accuracy and variations in rotation control of the polygon mirror. An optical sensor is generally arranged beside the photosensitive body, and a scanning start sync signal is output in response to incidence of scanning light. The optical scanning mechanism 304 corresponds to a scanning control unit in the appended claims.

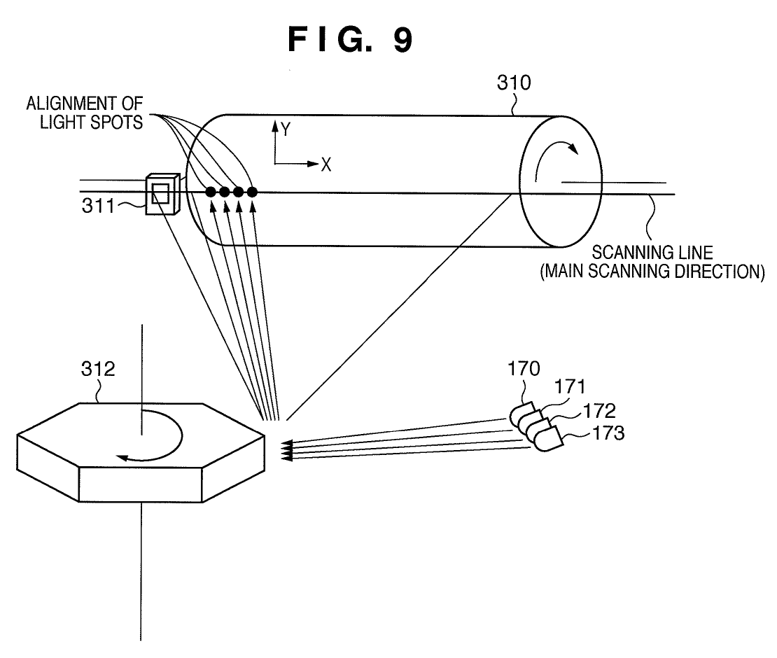

FIG. 9 is a view exemplifying an optical system included in the optical scanning mechanism 304 used in the image forming apparatus according to the first embodiment.

A latent image based on a formation image is formed on a photosensitive body 310 by light emitted by a light source. A synchronization sensor 311 is the above-mentioned optical sensor arranged on an extension of the scanning line to generate the above-mentioned sync signal. Before scanning the photosensitive body 310, light scanned by a polygon mirror 312 enters the synchronization sensor 311. The synchronization sensor 311 is an optical sensor with high time response. The synchronization sensor 311 is used as a synchronization trigger for outputting a formation image in the formation image rasterization area 301.

After the synchronization sensor 311 confirms a sync signal, the light sources 170 to 173 are turned off before light beams emitted by them reach the photosensitive body. Line information of a formation image input from the timing arbitration mechanism 108 is switched to serve as an emission driving source.

By rotating the polygon mirror 312, light emitted by the light source scans the synchronization sensor 311 and photosensitive body 310. As described above, light having passed through an optical correction system (not shown) scans the photosensitive body at a constant speed.

In the optical system of the image forming apparatus 10 according to the first embodiment, light beams emitted by the light sources 170 to 173 are aligned in the main scanning direction (X direction) on the photosensitive body, i.e., overwrite (compose) a single scanning line, which will described in detail later. In a conventional simultaneous scanning system using multiple light sources described in the Background Art, light beams emitted by the light sources 170 to 173 are aligned in the sub-scanning direction (Y direction) on the photosensitive body, and the respective light spots scan different scanning lines.

Referring back to FIG. 6, the timing arbitration mechanism 108 according to the first embodiment includes a discretization unit 151 for discretizing a waveform, which is as a feature of the present invention. The discretization unit 151 corresponds to a signal generation unit in the appended claims. The timing arbitration mechanism 108 further includes pulse extension units 152 to 155 for extending the pulses of discretized waveforms. In the following description, the pulse extension units 152 to 155 have a simple circuit arrangement as shown in FIG. 2.

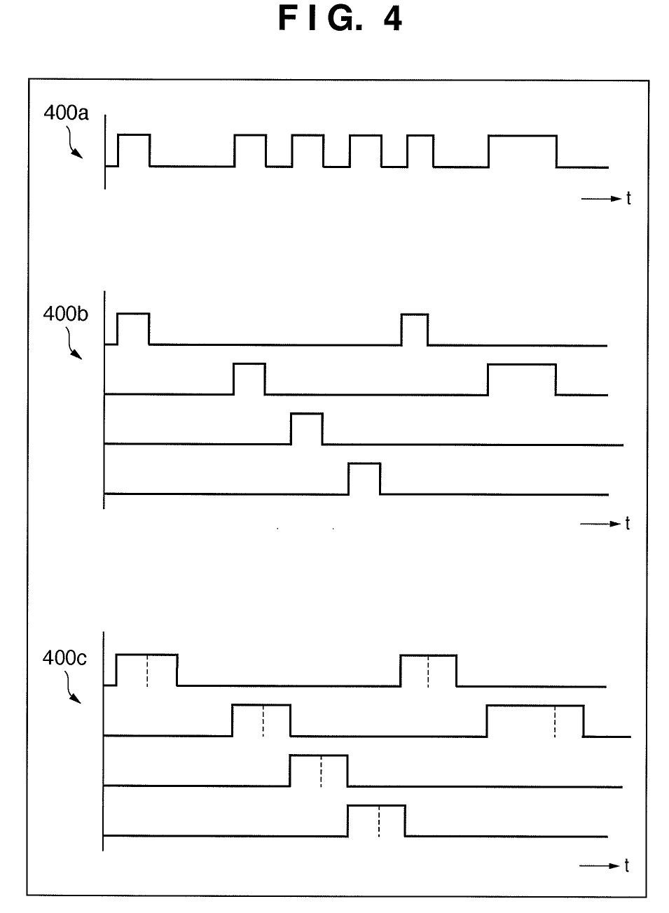

FIG. 4 is a timing chart exemplifying processing of an input line signal. A line signal 400a (image data of one scanning) is input from the line buffer 150 of the timing arbitration mechanism 108. The discretization unit 151 receives the line signal and discretizes it into four discrete line signals as represented by 400b based on the logic (to be described later). The pulse extension units 152 to 155 correct the waveforms of the respective discrete line signals, obtaining four corrected discrete line signals as represented by 400c.

In FIGS. 4, 6, and 9, the discretization unit 151 discretizes a line signal extracted from a formation image into four signals. However, the discretization count is not limited to four and can take an arbitrary value suited to the system configuration. This also applies to driving circuits 190 to 193 (to be described later), and the light sources or laser diodes 170 to 173. The number of driving circuits and that of laser diodes are not limited to four, and are determined by the number of light sources which scan a single track on the photosensitive body. Note that k represents the discretization count (=the number of superposed light sources).

As described with reference to FIG. 2, when the pulse width is extended, data needs to be transmitted at a timing earlier than an original transmission timing by the time corresponding to the response delay amount. The image write timing is determined by, e.g., a preset time after the synchronization sensor 311 beside the photosensitive body detects incident light.

Reference numerals 230 to 233 denote position adjustment units. The light sources 170 to 173 are arranged at physically slightly different positions, and when driven at the same timing, light beams from them shift from each other by several to several ten pixels in the main scanning direction on the scanning line. For example, when the projection interval between a given light source and another one in the main scanning direction is 420 μm, light beams from them shift from each other by 10 pixels for 600 dpi and 40 pixels for 2,400 dpi. It is, therefore, necessary to adjust the driving timing (output timing) and correct the position. The position adjustment units 230 to 233 are prepared to correct the timing in accordance with the positional difference. More specifically, the physical positional difference is corrected by adjusting the scanning timing. The position adjustment units 230 to 233 can also be formed from only simple delay elements. The order of signal processes by the pulse extension units 152 to 155 and position adjustment units 230 to 233 may also be reversed. Alternatively, the pulse extension units 152 to 155 and position adjustment units 230 to 233 may also perform processes simultaneously.

The driving circuits 190 to 193 drive the laser diodes 170 to 173 serving as light sources. The driving circuits 190 to 193 convert a signal of logic circuit level into a voltage current enough to drive the laser diode.

<Details of Signal Processing>

In the following description, a High line signal means rendering (=laser emission), and a Low line signal means no rendering (=no laser emission). In this case, the signal is corrected when it is at High level.

The discretization unit 151 is a configured as a state transition circuit having one input, k outputs, and k states. When the state transition circuit is in the state i, it outputs an input to an output i. The remaining output values are at Low level.

The state transition circuit changes the state at the trailing edge of the pulse (shift from High to Low), and shifts from the state i to the state i+1. When i=k, the state changes to i=0. This is given by

i=(i+1) mod k

(where mod is a remainder operator.)

The waveform discretization unit 151 receives a line signal read out from the line buffer 150. Based on the received line signal, the waveform discretization unit 151 sequentially changes the state, discretizes pulses, and outputs them to k sub-rendering signal lines. The k sub-rendering signal lines are connected to the separate pulse width extension units 152 to 155. The pulse width may also be extended by an analog circuit or digital signal conversion.

The pulse width extension amount needs to be adjusted by a unit smaller than the width of one pixel of the image forming unit. To digitally extend the pulse width, an image signal is converted so that it can be adjusted by small sub-pixels by oversampling or the like. More specifically, the pulse is extended by adding a predetermined number of sub-pixels to it. This value can be obtained by changing the register set value, and can be easily adjusted without selecting a delay element which provides an optimal value, unlike a case wherein an analog circuit extends the pulse.

Sub-pixel processing needs to be done at a frequency (temporal resolution) higher than that of an original image signal. However, a logic circuit feasible in a semiconductor chip can use a frequency higher than the response speed of a light-emitting element at low cost. Hence, such a system can be built easily.

The light source driving circuits 190 to 193 receive, as separate light source rendering signals, sub-rendering signals having passed through the respective pulse width extension units.

The individual laser diodes 170 to 173 are turned on/off based on pulse width-corrected sub-rendering signals. The optical system scans emitted light beams to guide them onto the photosensitive body. The light beams emitted by the respective light sources scan the same track on the photosensitive body. Latent images formed on the photosensitive body comply with rendering signals.

The signal division count k suffices to be determined by the emission delay amount τ and the minimum interval between pulses generated in rendering. The minimum interval is generally the width w of one pixel. A conventional image forming unit in which τ is much smaller than w does not require correction. If w>τ, the present invention can be practiced at k=2. Considering the operation margin, k=3 is desirable when the w and τ values are close to each other. In general, it is preferable to select a minimum k value which satisfies

k×w>τ>(k−1)×w

By selecting the minimum k value in this manner, a minimum optical system can execute correction at the lowest cost. As a laser array with multiple light sources, those with a power-of-two number of elements are often manufactured. For this reason, a power-of-two value larger than the minimum k value may also be selected.

<Operation of Apparatus>

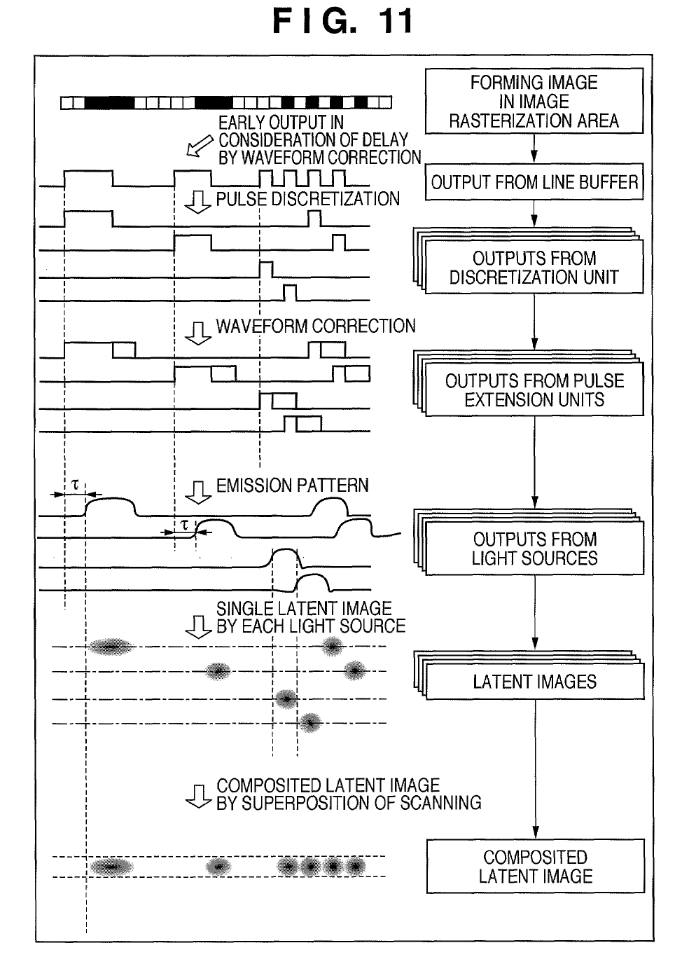

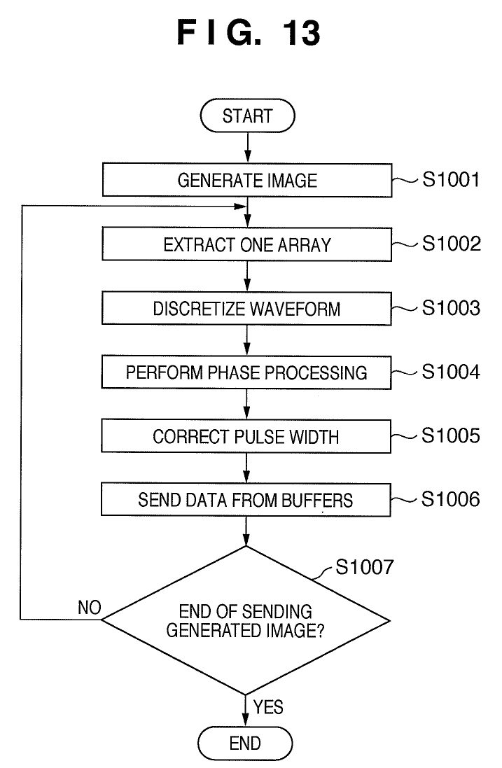

FIG. 13 is a flowchart of the operation of the image forming apparatus according to the first embodiment. The arithmetic unit 103 implements the following operation by executing a control program stored in the storage unit 104 and controlling the output control unit 105. FIG. 11 is a view exemplifying an image signal in each internal mechanism of the image forming apparatus.

In step S1001, various mechanisms generate a formation image in the rasterization area 301 in accordance with input image information.

In step S1002, the line buffer 150 sequentially extracts pixel arrays from the formation image.

In step S1003, the waveform discretization unit 151 generates partial pixel arrays discretized based on the pixel arrays stored in the line buffer 150, and inputs them to the extension units 152 to 155.

In steps S1004 and S1005, the position adjustment units 230 to 233 and extension units 152 to 155 correct timing (phase) shifts arising from the physical arrangement of emission points, and pulse widths.

In step S1006, the light source driving circuits 190 to 193 receive the signals processed in steps S1004 and S1005.

In step S1007, it is checked whether all pixel arrays included in the formation image have been processed. If an unprocessed pixel array remains, the process returns to step S1002. If all pixel arrays have been processed, the process ends.

As described above, the image forming apparatus according to the first embodiment can increase resolution in the main scanning direction by a simple arrangement. Especially in high-speed rendering, a combination of the waveform discretization unit, and optical scanning of a single track or superposed tracks by light sources can implement high resolution in the main scanning direction, which is difficult to achieve by only signal processing of an electronic circuit system. The use of light sources integrated into a one-chip device can increase resolution while reducing the cost.

### Second Embodiment

The second embodiment will explain an image forming apparatus with a light source having M light-emitting portions arranged two-dimensionally. At least one of the M light-emitting portions is not positioned on the same line as that of the remaining light-emitting portions. The internal arrangement of the image forming apparatus except for the timing arbitration mechanism and optical scanning mechanism is the same as that in the first embodiment, and a description thereof will not be repeated. The operation of the apparatus is also almost the same as that in the first embodiment, and a description thereof will not be repeated.

<Apparatus Arrangement>

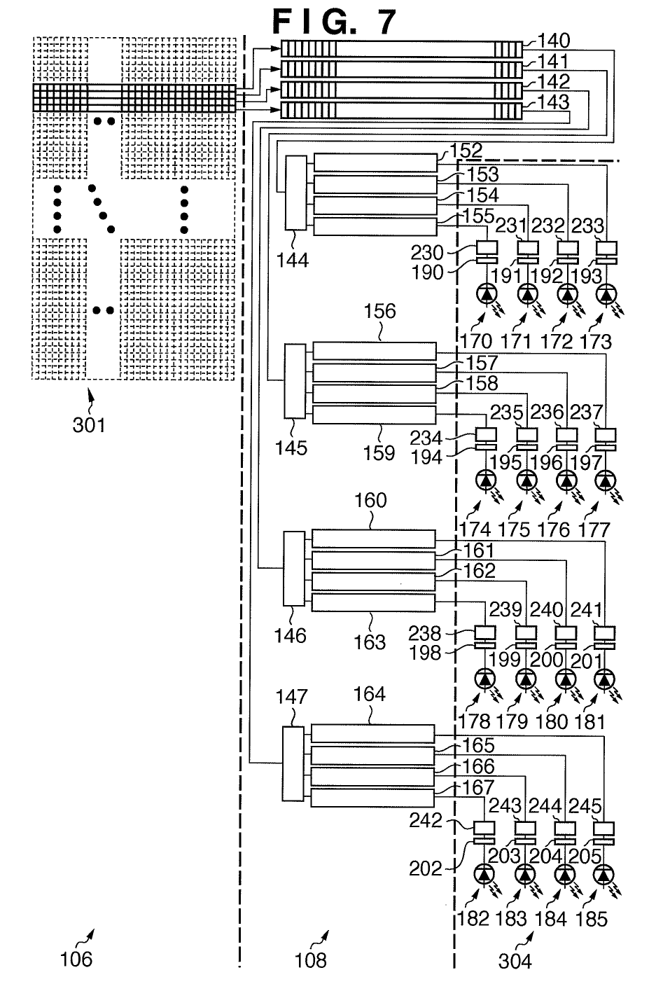

FIG. 7 is a view exemplifying a state in which the timing arbitration mechanism of the image forming apparatus according to the second embodiment transfers data to the optical scanning mechanism. Especially in FIG. 7, the simultaneous rendering count in the sub-scanning direction is 4, and the superposed rendering count k in the main scanning direction is 4.

To simultaneously render four scanning lines, four line buffers 140 to 143 are necessary. The line buffers 140 to 143 hold respective pieces of information for four arrays of a formation image rasterization area 301, and output them based on a timing signal generated by the optical scanning mechanism.

Waveform discretization units 144 to 147 discretize waveforms output from the line buffers 140 to 143. As building elements, a timing arbitration mechanism 108 includes extension units 152 to 167 for extending the pulse width, and driving circuits 190 to 205. Each of a group of laser diodes 170 to 173, a group of laser diodes 174 to 177, a group of laser diodes 178 to 181, and a group of laser diodes 182 to 185 scans the same track.

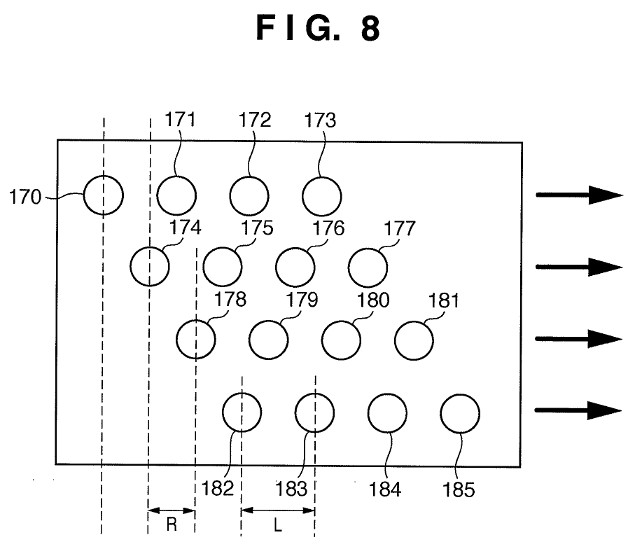

FIG. 8 is a view exemplifying the layout of laser diodes on a semiconductor chip.

As shown in FIG. 8, emission points in the main scanning direction and sub-scanning direction are not always on lines orthogonal to each other. That is, emission points need not be arranged along X and Y orthogonal axes. Depending on heat radiation and the wiring pattern, the emission points of laser diodes are not necessarily arranged in a square grid pattern on a semiconductor chip. The emission points are often arranged in a parallelogram so that the interval between emission points coincides with the scanning density while increasing the setting interval.

In this arrangement, position adjustment units 230 to 245 need to perform correction in consideration of the timing shift in the sub-scanning direction in addition to the shift between superposed light sources. Hence, the position adjustment units 230 to 245 adjust these timings.

Even in optical scanning with multiple light sources, image synchronization for the image forming unit is desirably done for each scanning line. However, for an image forming unit which simultaneously renders a plurality of scanning lines by a plurality of light sources aligned in the sub-scanning direction, it is difficult to separate individual light beams. The interval between light sources is merely 42 μm even in a 600-dpi apparatus, and becomes ¼ that in a 2,400-dpi apparatus.

For this reason, the optical response speed and coordinate resolution need to be increased to discriminate light beams from individual light sources by a synchronization sensor 311 serving as a synchronization detection sensor. In addition, it is necessary to arrange many elements, and adjust physical positions at high manufacturing cost. In practice, to prevent the increase in cost, it is preferable to generate the timings of the respective position adjustment units by using a light beam entering the sensor earliest as the sync signal of a multi-light-source device, and calculating the remaining timings from the interval between the light sources of the device.

As shown in FIG. 8, L (μm) represents the interval between light sources which are arranged in the main scanning direction and scan the same track. R (μm) represents the shift in the main scanning direction between light sources at different scanning positions. Letting dx and dy be light source shift amounts, the amount of scanning delay of an arbitrary light source from a light source which scans the synchronization sensor 311 and a photosensitive body 310 earliest satisfies

dx×L+dy×R

Letting S (μm/sec) be the optical scanning speed, the temporal correction amount of this shift amount is given by

(dx×L+dy×R)/S

The position adjustment units 230 to 245 perform this temporal correction.

As described above, the image forming apparatus according to the second embodiment can increase resolution in the main scanning direction by a simple arrangement. In particular, the image forming apparatus can increase the image forming speed by simultaneously processing a plurality of pixel arrays.

### Third Embodiment

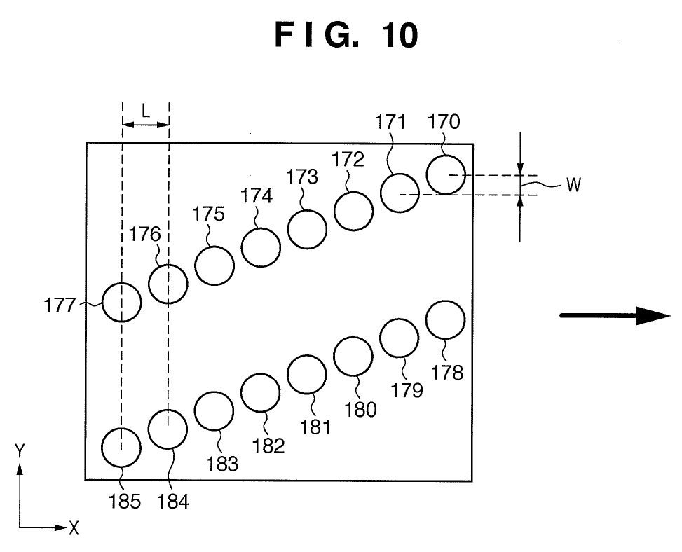

Devices with multiple element light sources on one chip include a device designed to increase density in only one direction. In this device, light sources are arranged in line in principle. In some devices, light sources are arranged by repetitively arranging them several times in order to suppress the chip width (Y direction in FIG. 10). The third embodiment will exemplify a device with a repetitive arrangement.

FIG. 10 is a view exemplifying a light source arrangement in the device with a repetitive arrangement. Light sources are laid out at equal intervals W in the sub-scanning direction.

When a device with this arrangement is employed and a laser beam from the light source has a spot diameter of ten-odd to several ten μm, most of irradiation light beams from not only adjacent light sources but also neighboring light sources overlap each other. For this reason, even a device designed to increase resolution in the sub-scanning direction can also be applied to increase resolution in the main scanning direction.

For example, in a chip designed at a resolution of 9,600 dpi in the sub-scanning direction, W corresponding to the pixel interval is merely 2.65 μm. When the laser spot diameter is 20 μm, the scanning area overlaps an adjacent pixel by 87%. Hence, adjacent light sources can be grouped, and the same method as that described in the first or second embodiment can be adopted.

Assume that the device in FIG. 10 is a 9,600-dpi device with an emission point arrangement interval W=2.65 μm. In this case, laser diodes are divided into four groups of laser diodes 170 to 173, 174 to 177, 178 to 181, and 182 to 185. That is, adjacent light-emitting elements in the sub-scanning direction are grouped, and scanning tracks in each group are regarded as virtually the same track. In this case, k=4, and this semiconductor chip can be regarded to be identical to the one according to the second embodiment. However, the position adjustment unit needs to adjust a scanning delay dependent on the arrangement position of each light-emitting element.

The device shown in FIG. 10 will be exemplified. The coordinates of light sources with respect to the light sources 170 and 178 whose light beams enter the sensor earliest are given by

dx×L (where dx=1 to 7)

Letting S (μm/sec) be the optical scanning speed, the temporal correction amount can be calculated by

(dx×L)/S

For k=4, the image forming apparatus functions as a 2,400-dpi apparatus in the sub-scanning direction. Grouping can be arbitrary for a device in which light sources are aligned at high density and equal intervals in the sub-scanning direction. The device can be designed in accordance with the image forming speed as long as large parts of light spots superpose each other.

For example, when the laser diodes are divided into three groups of the laser diodes 170 to 174, 175 to 179, and 180 to 184 without using the laser diode 185, the discretization count k is 5, and the image forming apparatus functions as a 1,920-dpi apparatus in the sub-scanning direction. When the laser diodes are divided into groups of the laser diodes 170 to 172, 173 to 175, 176 to 178, 179 to 181, and 182 to 184, the discretization count k is 3, and the image forming apparatus functions as a 3,200-dpi apparatus in the sub-scanning direction.

However, when the discretization count k is set large with respect to the spot diameter, no tracks can be regarded as approximately the same one. For example, when the spot diameter is 20 μm and the discretization count k increases up to k=5, the scanning interval between light sources at two ends which are most spaced apart from each other is

2.65×4=10.6

The superposition ratio of the scanning area then becomes lower than 50%, and it becomes difficult to regard tracks as the same one.

However, when the spot diameter of the light source is 30 μm, even if the discretization count k increases up to k=6, the scanning interval between light sources at two ends is

2.65×5=13.25

In this case, a scanning area superposition ratio of 65% can be ensured, and tracks can be regarded as the same one.

For this reason, the upper limit of the discretization count k is desirably determined based on the interval between light sources in the sub-scanning direction and the spot diameter of the light source.

As described above, the image forming apparatus according to the third embodiment uses a light source device with a repetitive arrangement. The image forming apparatus can increase resolution in the main scanning direction by a simple arrangement.

### Fourth Embodiment

The fourth embodiment will exemplify a case wherein timing correction based on the physical arrangement of optical elements, correction of the emission delay amount, and the like are executed by deforming a formation image in the rasterization area. That is, the fourth embodiment will explain an arrangement which shifts the pixel position in a formation image to convert the pixel array pattern, thereby obviating or reducing the need for timing adjustment by a subsequent mechanism.

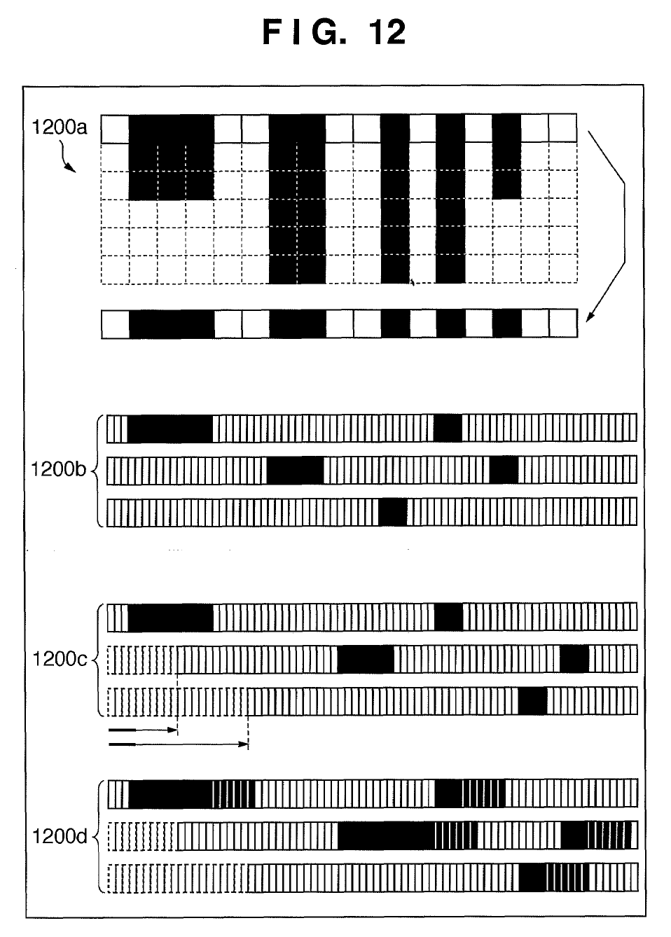

FIG. 12 is a view exemplifying deformation of a formation image. In an image 1200a, the upper stage represents a rasterized formation image, and the lower stage represents the first array extracted from the rasterized formation image. The array of the formation image undergoes the following processing.

Processing corresponding to the waveform discretization unit 151 in the first embodiment is executed to generate discrete signals. An image 1200b represents discrete signals with the discrete count k=3. At the same time, the resolution in the scanning direction is converted into a higher one in order to finely correct the timing. In the signals indicated by the image 1200b, the resolution is quadrupled in the scanning direction. A large-capacity memory is necessary to store this data. For example, the example 1200b requires a memory capacity as large as about 12 times (=3×4).

Pixel data shift processing is done to correct a delay dependent on the physical arrangement of light sources. An image 1200c represents shifted discrete signals in which the pixels of data in the signals 1200b are shifted for delay correction. Further, pixel data extension processing is performed for emission delay correction. An image 1200d represents extended and shifted discrete signals. An extension processing is done for data in the signals 1200c. The order of pixel data shift processing and extension processing can be arbitrarily set, and either processing can be executed first.

High-resolution line buffer data obtained in this way are sequentially sent to the laser driving circuit. As a result, the resolution in the main scanning direction can be increased without arranging mechanisms corresponding to the waveform discretization unit, pulse extension unit, and position adjustment unit in the first embodiment. That is, a software configuration can replace part of the physical circuit.

### Other Embodiments

The embodiments of the present invention have been described in detail. The present invention may be applied to a system including a plurality of devices or an apparatus formed by a single device.

The present invention is also achieved by supplying a program for implementing the functions of the above-described embodiments to a system or apparatus directly or from a remote place, and reading out and executing the supplied program codes by the system or apparatus. Program codes themselves installed in the computer in order to implement functional processes of the present invention by the computer also fall within the technical scope of the present invention.

In this case, the present invention may take any program form such as an object code, a program executed by an interpreter, or script data supplied to an OS as long as a program function is attained.

Examples of a recording medium for supplying the program are a Floppy® disk, hard disk, optical disk (CD or DVD), magnetooptical disk, magnetic tape, nonvolatile memory card, and ROM.

The functions of the above-described embodiments are implemented when the computer executes the readout program. The functions of the above-described embodiments can also be implemented when an OS or the like running on the computer performs some or all of actual processes on the basis of the instructions of the program.

Further, the functions of the above-described embodiments are implemented when the program read out from the recording medium is written in the memory of a function expansion board inserted into the computer or the memory of a function expansion unit connected to the computer, and the CPU of the function expansion board or function expansion unit performs some or all of actual processes on the basis of the instructions of the program.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2008-127379, filed May 14, 2008, which is hereby incorporated by reference herein in its entirety.

What is claimed is:

1. An image forming apparatus comprising:
a light source having N (N is an integer of not less than 2) light-emitting portions each configured to emit a light beam based on an input image signal;
input unit for inputting image data;
signal generation unit for extracting one-scanning image data corresponding to one scanning based on the input image data, and generating N image signals which form the one-scanning image data upon composition; and
scanning control unit for scanning a single track on a photosensitive body by N light beams emitted by said light source to form a latent image corresponding to the one-scanning image data on the photosensitive body.

2. The apparatus according to claim 1, wherein said scanning control unit controls output timings of light beams to be emitted by the N light-emitting portions based on positions of the N light-emitting portions of said light source.

3. The apparatus according to claim 1, wherein said signal generation unit generates an image signal which compensates for deterioration of a signal caused by a response delay of the light-emitting portion.

4. The apparatus according to claim 3, wherein said signal generation unit generates an image signal which compensates for deterioration of a signal by a delay element and an OR element.

5. The apparatus according to claim 1, wherein the image signal is generated as a pulse signal, and each of the N image signals is generated to make an interval between adjacent pulses included in each image signal larger than a preset interval.

6. The apparatus according to claim 1, wherein the N light-emitting portions are arranged one-dimensionally in said light source.

7. The apparatus according to claim 1, wherein
M (integer: M>N) light-emitting portions are arranged two-dimensionally in said light source, and
at least one of the M light-emitting portions is configured to scan a track different from a track scanned by the N light-emitting portions.

8. A method of controlling an image forming apparatus using a light source having N (N is an integer of not less than 2) light-emitting portions each configured to emit a light beam based on an input image signal, the method comprising:
an input step of inputting image data;
a signal generation step of extracting one-scanning image data corresponding to one scanning based on the input image data, and generating N image signals which form the one-scanning image data upon composition; and
a scanning control step of scanning a single track on a photosensitive body by N light beams emitted by the light source to form a latent image corresponding to the one-scanning image data on the photosensitive body.
